(19) United States
(12) Patent Application Publication
(10) Pub. No.: US 2015/0375616 A1
(43) Pub. Date: Dec. 31, 2015

(54) TANK ASSEMBLY FOR MACHINES

(71) Applicant: Caterpillar Inc., Peoria, IL (US)

(72) Inventors: Baljinder H. Singh, Bloomington, IL (US); Nirav H. Doshi, Decatur, IL (US); Maheswaran Chinnasamy, Decatur, IL (US)

(73) Assignee: Caterpillar Inc., Peoria, IL (US)

(21) Appl. No.: 14/852,615

(22) Filed: Sep. 13, 2015

(51) Int. Cl. B60K 15/073

(52) U.S. Cl. CPC B60K 15/073; B60K 2015/03151

(57) ABSTRACT

A machine with a frame, a fuel tank, and a reductant tank is provided. The fuel tank includes a first L-shaped wall, a second L-shaped wall, and a peripheral wall assembly. The first L-shaped wall includes a first edge and a second edge. The second L-shaped wall includes a third edge and a fourth edge. The peripheral wall assembly is disposed around the first L-shaped wall and second L-shaped wall to define a fuel tank volume. The peripheral wall assembly includes a first support surface and a second support surface. The first support surface extends between the first edge and the third edge. The second support surface extends between the second edge and the fourth edge. The first support surface is perpendicularly attached to the second support surface, to define a notched space. The reductant tank is retained in the notched space.

### TECHNICAL FIELD

The present disclosure generally relates to fuel tanks of machines such as off-highway trucks, wheel loaders, and/or the like. More particularly, the present disclosure relates to a tank assembly which provides a design such that another tank is nested with a fuel tank.

### BACKGROUND

Byproducts of combustion engines, such as diesel engines, are various emissions such as nitrogen oxide emissions (NOx). In response to government-mandated regulations over such emissions, manufacturers of internal combustion engines have developed measures to reduce the amount or effect of the nitrogen oxides produced by the engines. Therefore, an aftertreatment system is associated with an engine system. The aftertreatment system is configured to treat and reduce NOx and/or other compounds of the emissions present in an exhaust gas flow, prior to the exhaust gas flow exiting into the atmosphere. In order to reduce NOx, the aftertreatment system may include a selective catalytic reduction (SCR) module and a reductant delivery module. The reductant delivery module may include a reductant tank for storage of a reductant, a reductant pump, reductant delivery lines and a reductant injector.

In case of large machines such as large mining trucks, large fuel tanks may be used. Since, the amount of reductant consumption is dependent on fuel consumption, therefore there may be need to increase reductant storage volume for the machine. Storage of increased volume of the reductant may be a concern as it is unfavorable to mix the reductant with other fluids for storage, due to the chemical nature of the reductant. Also, due to temperature concerns, it is unfavourable to store the reductant inside engine compartment. Hence, with increase in size of the fuel tanks, the SCR modules may require large reductant tanks to meet tier-4 emission norms, in such large machines. Large reductant tanks are heavy and may not fit well in the current machine frame. Further, the positioning of the reductant tank should provide easy ground level serviceability for reductant fill operation.

U.S. Pat. No. 8,985,262 discloses a tank unit with a housing. The housing accommodates a fuel tank and a reductant tank, with filler openings disposed on an outer surface of the housing. The 262' reference discloses a design of the tank unit which may pose positioning concerns in case of increase in size of the fuel tanks. This may also require re-manufacturing of the housing, owing to larger tank sizes.

The present disclosure seeks to address one or more of the problems associated with known.

### SUMMARY OF THE INVENTION

Various aspects of the present disclosure relate to a machine, which includes a frame, a fuel tank, and a reductant tank. The fuel tank is attached to the frame. The fuel tank includes a first L-shaped wall, a second L-shaped wall, and a peripheral wall assembly. The first L-shaped wall includes a first edge and a second edge. The second L-shaped wall includes a third edge and a fourth edge. The peripheral wall assembly is attached around the first L-shaped wall and second L-shaped wall to define a fuel tank volume. The peripheral wall assembly includes a first support surface and a second support surface. The first support surface extends between the first edge of the first L-shaped wall and the third edge of the second L-shaped wall. The second support surface extends between the second edge of the first L-shaped wall and the fourth edge of the second L-shaped wall. The first support surface is perpendicularly attached to the second support surface. The first support surface and the second support surface define a notched space of the fuel tank. The reductant tank is retained in the notched space such that the reductant tank is attached to the first support surface and the second support surface.

### BRIEF DESCRIPTION OF THE DRAWINGS

FIG. 1 is a diagrammatic view of a machine with body removed to show a frame and a tank assembly, in accordance with the concepts of the present disclosure;

FIG. 2 is a perspective view of a first side of the tank assembly of FIG. 1, in accordance with the concepts of the present disclosure;

FIG. 3 is a perspective view of a second side of the tank assembly of FIG. 1, in accordance with the concepts of the present disclosure;

FIG. 4 is an exploded view of the tank assembly of FIG. 1, showing a reductant tank separated from a fuel tank, in accordance with the concepts of the present disclosure.

### DETAILED DESCRIPTION

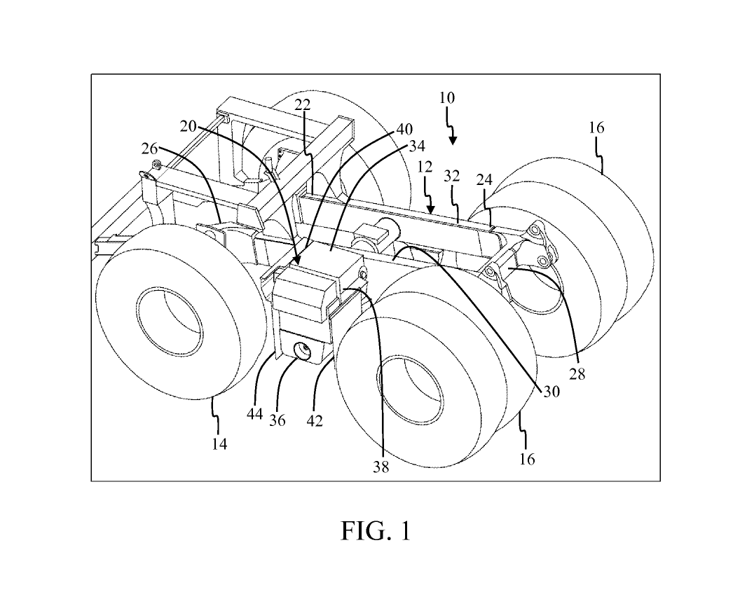

Referring to FIG. 1, there is shown an exemplary machine 10. Although the machine 10 shown is an off-highway truck, but the disclosure is applicable to other machines such as mining trucks, dump trucks, wheel loaders, and/or the like. The machine 10 is shown with a frame 12, front wheels 14, rear wheels 16, and a tank assembly 20. The machine 10 also includes a body (not shown) mounted and attached to the frame 12.

The frame 12 extends in a fore-aft direction of the machine 10. The frame 12 includes a front portion 22 and a rear portion 24. The front portion 22 of the frame 12 is provided with the front wheels 14. Also, both sides of the rear portion 24 of the frame 12 are provided with the rear wheels 16.

The front portion 22 includes a front axle 26. The rear portion 24 includes a rear axle 28. Longitudinal frame members 30 and 32 are positioned between the front axle 26 and the rear axle 28. The longitudinal frame member 30 includes mounting structures to facilitate mounting of the tank assembly 20.

The tank assembly 20 is attached to the longitudinal frame member 30. The tank assembly 20 is an aggregation of a fuel tank 34 and a reductant tank 36. The tank assembly 20 includes a first end 38 and a second end 40. The first end 38 is proximal to the rear wheels 16 and the second end 40 is proximal to the front wheels 14. The tank assembly 20 is protected by a first mudguard 42 and a second mudguard 44. The first mudguard 42 is positioned near the first end 38 and the second mudguard 44 is positioned near the second end 40.

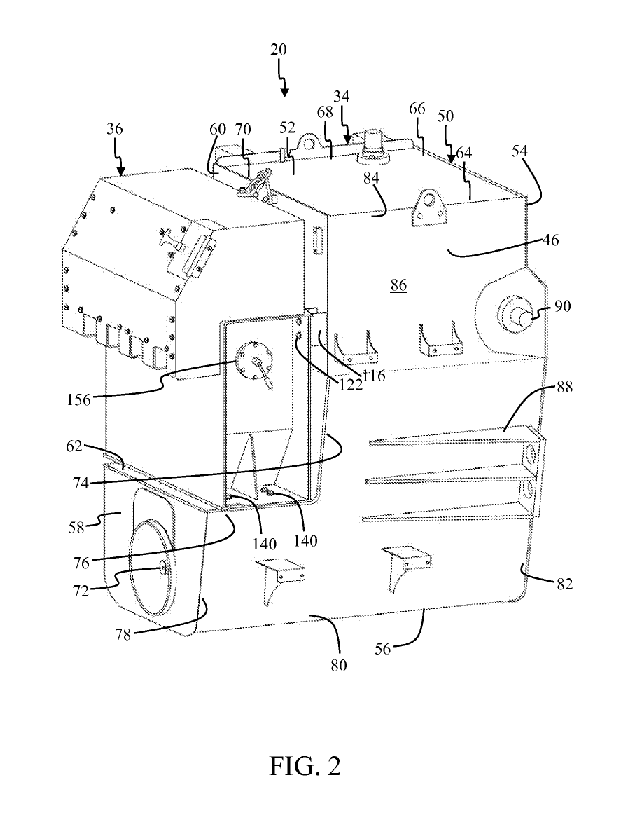

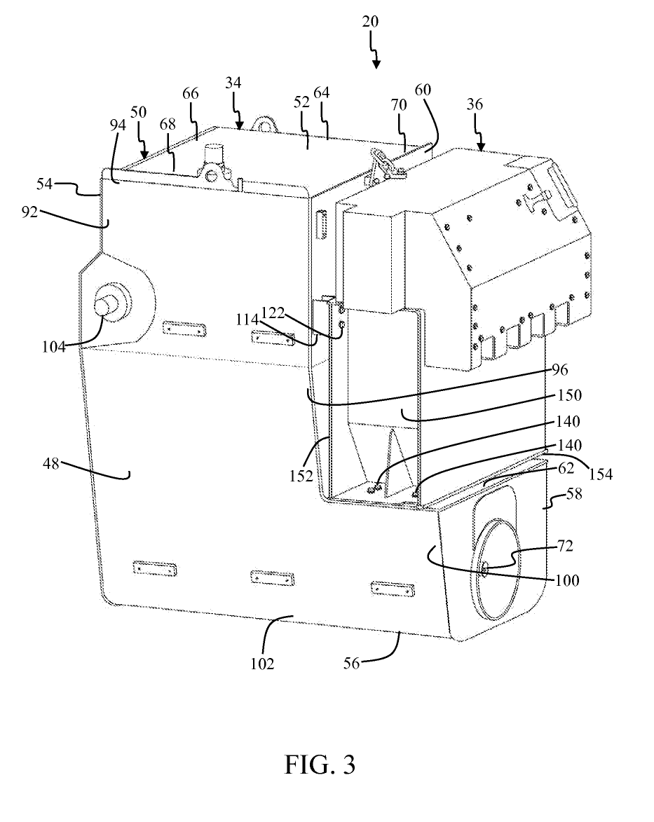

Referring to FIGS. 2 and 3, there is shown the tank assembly 20. The tank assembly 20 includes the fuel tank 34 and the reductant tank 36. The fuel tank 34 stores fuel and further supply the fuel to the engine (not shown). The fuel tank 34 includes a first L-shaped wall 46, a second L-shaped wall 48, and a peripheral wall assembly 50.

The peripheral wall assembly 50 is disposed between the first L-shaped wall 46 and second L-shaped wall 48 to define a fuel tank volume. The peripheral wall assembly 50 is attached to the first L-shaped wall 46 and the second L-shaped wall 48. The peripheral wall assembly 50 runs along peripheries of the first L-shaped wall 46 and second L-shaped wall 48. The peripheral wall assembly 50 includes a top wall 52, a back wall 54, a bottom wall 56, a front wall 58, a first support surface 60, and a second support surface 62.

The top wall 52 includes a first edge 64, a second edge 66, a third edge 68, and a fourth edge 70. The first edge 64 is attached to the first L-shaped wall 46. The second edge 66 is attached to the back wall 54. The third edge 68 is attached to the second L-shaped wall 48. The fourth edge 70 is attached to the first support surface 60.

The front wall 58 is peripherally surrounded by the first L-shaped wall 46, the second L-shaped wall 48, the bottom wall 56, and the peripheral wall assembly 50. The front wall 58 includes a fuel fill port 72 to facilitate fuel-filling operation.

The first L-shaped wall 46 includes a first edge 74, a second edge 76, a third edge 78, a fourth edge 80, a fifth edge 82, and a sixth edge 84. The first edge 74 and the second edge 76 are indented from the sixth edge 84 and the third edge 78, respectively. The third edge 78 is attached to the front wall 58. The fourth edge 80 is attached to the bottom wall 56. The fifth edge 82 is attached to the back wall 54. The sixth edge 84 is attached to the first edge 64 of the top wall 52.

An outer surface 86 of the first L-shaped wall 46 includes a mounting bracket 88 and a shaft portion 90. The shaft portion 90 is attached to the outer surface 86 and protrudes outwards and away from the first L-shaped wall 46. The shaft portion 90 is proximal to the top wall 52. The mounting bracket 88 is attached onto the outer surface 86, proximal to the bottom wall 56. The shaft portion 90 is attached to the outer surface 86 and protrudes outwards and away from the first L-shaped wall 46. The mounting bracket 88 is attached onto the outer surface 86, proximal to the bottom wall 56. The mounting bracket 88 is a ribbed structure to facilitate attachment of the first mudguard 42 and also attachment of the fuel tank 34 to the frame 12.

Similarly, the second L-shaped wall 48 includes a first edge 92, a second edge 94, a third edge 96, a fourth edge 98, a fifth edge 100, and a sixth edge 102. The first edge 92 is attached to the back wall 54. The second edge 94 is attached to the third edge 68 of the top wall 52. The third edge 96 and the fourth edge 98 are indented from the second edge 94 and the fifth edge 100, respectively. The fifth edge 100 is attached to the front wall 58. The sixth edge 102 is attached to the bottom wall 56.

An exterior surface of the second L-shaped wall 48 includes a shaft portion 104. The shaft portion 104 is attached proximal to the top wall 52. The shaft portion 104 protrudes away from the exterior surface. The shaft portion 104 is provided for attachment to the frame 12.

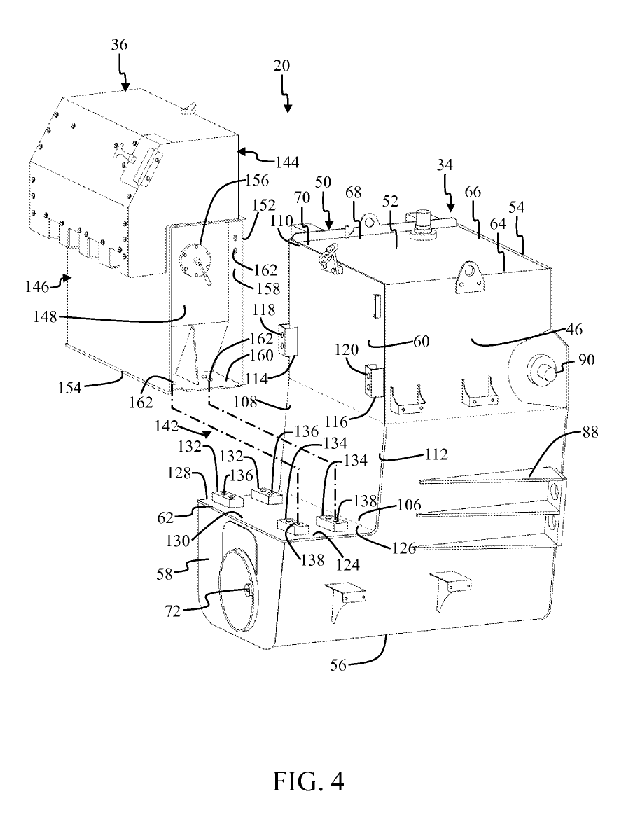

Referring to FIG. 4, the first support surface 60 is a vertical member and extends between the first edge 74 of the first L-shaped wall 46 and the third edge 96 of the second L-shaped wall 48. The first support surface 60 includes a first end 106, a second end 108, a third end 110, and a fourth end 112. The first end 106 is attached to the second support surface 62. The second end 108 is attached to the third edge 96 of the second L-shaped wall 48. The third end 110 is attached to the fourth edge 70 of the top wall 52. The fourth end 112 is attached to the first edge 74 of the first L-shaped wall 46.

The first support surface 60 includes a first mount member 114 and a second mount member 116. The first mount member 114 is disposed at the second end 108 and the second mount member 116 is disposed at the fourth end 112. The mount members 114 and 116 are provided to facilitate attachment of the reductant tank 36. The mount members 114 and 116, respectively, include holes 118 and 120 for insertion of fasteners 122 (FIGS. 2 and 3) to attach the reductant tank 36.

The second support surface 62 is a horizontal member and is aligned perpendicular to the first support surface 60. The second support surface 62 extends between the second edge 76 of the first L-shaped wall 46 and the fourth edge 98 of the second L-shaped wall 48. The second support surface 62 includes a first end 124, a second end 126, a third end 128, and a fourth end 130. The first end 124 is attached to the second edge 76 of the first L-shaped wall 46. The second end 126 is attached to the first end 106 of the first support surface 60. The third end 128 is attached to the fourth edge 98 of the second L-shaped wall 48. The fourth end 130 is attached to the front wall 58.

The second support surface 62 includes a first pair of mount members 132 and a second pair of mount members 134. The mount members 132 are disposed at the first end 124 and the mount members 134 are disposed at the third end 128. The mount members 132 and 134 are provided to facilitate attachment of the reductant tank 36. The mount members 132 and 134, respectively, include holes 136 and 138 for insertion of fasteners 140 (FIGS. 2 and 3) to attach the reductant tank 36.

The alignment of the first support surface 60 relative to the second support surface 62 defines a notched space 142 of the fuel tank 34. The notched space 142 is imparts an L-shape to the fuel tank 34.

Typically, the reductant tank 36 is a part of an exhaust aftertreatment system (not shown). The reductant tank 36 stores reductant. The reductant is introduced into exhaust gas for conversion of nitrogen oxides to chemicals such as nitrogen (N₂) and water (H₂O) in the presence of a catalyst. In an exemplary embodiment, the reductant may be ammonia, or other nitrogen based products and catalyst may be made up of platinum or platinum alloys. The reductant tank 36, in an assembled state, is retained in the notched space 142 of the fuel tank 34. The reductant tank 36 includes an upper portion 144 and a lower portion 146. The upper portion 144 houses electronic components (not shown) of the reductant tank 36.

Referring to FIGS. 2, 3, and 4, the lower portion 146 defines a reductant volume for storage of the reductant. The lower portion 146 includes a first end 148, a second end 150, a longitudinal wall 152, and a base wall 154. For assembly, the reductant tank 36 is retained with the fuel tank 34 such that the longitudinal wall 152 aligns along the first support surface 60 and the base wall 154 aligns along the second support surface 62.

The first end 148 includes a reductant fill port 156, a first side plate 158, and a first bottom plate 160. The reductant fill port 156 is provide for filling operation of the reductant. The first side plate 158 and the first bottom plate 160 are provided with holes 162. The holes 162 facilitate attachment of the first side plate 158 and the first bottom plate 160 to the first support surface 60 and the second support surface 62, respectively, via the fasteners 140.

Similarly, the second end 150 includes a second side plate 164 and a second bottom plate 166. The second side plate 164 and the second bottom plate 166 are provided with holes (not shown). The holes (not shown) facilitate attachment of the second side plate 164 and the second bottom plate 166 to the first support surface 60 and the second support surface 62, respectively, via the fasteners 140.

### INDUSTRIAL APPLICABILITY

In operation, the reductant tank 36 is retained in the notched space 142 of the fuel tank 34. The notched space 142 includes a space nearly equal to a volume of the reductant tank 36, such that the fuel tank 34 accommodates the reductant tank 36. The reductant tank 36 is mounted in the notched space 142 via the fasteners 122 and 140, respectively, inserted in the mount members 114, 116, 132, and 134 attached to the first support surface 60 and the second support surface 62. The longitudinal wall 152 is mounted against the first support surface 60. The base wall 154 is mounted against the second support surface 62.

The disclosed tank assembly 20 is attached to the frame 12 of the machine 10, between the wheels 14 and 16. The fuel tank 34 and the reductant tank 36 are aligned in such manner that there is no space constraint for mounting of the tank assembly 20. Sizes of the fuel tank 34 and the reductant tank 36 are determined to occupy a pre-determined space envelope. The fill ports 72 and 156 of both the tanks 34 and 36 are positioned for convenience during filling operations. In addition, the disclosed tank assembly 20 is designed to provide ground serviceability. The disclosed tank assembly 20 reduces machine downtime, as both the tanks 34 and 36 can be filled from a single location. In addition, with no compromise with required volume of the fuel tank 34, the tank assembly 20 is structurally rigid and robust. The disclosed tank assembly 20 is also provided with mudguards 42 and 44 on both sides for protection from dust.

The many features and advantages of the disclosure are apparent from the detailed specification, and thus, are intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described herein. Accordingly, all suitable modifications and equivalents may be resorted to that fall within the scope of the disclosure.

What is claimed is:

1. A machine comprising:
a frame;
a fuel tank attached to the frame, the fuel tank including:
a first L-shaped wall having a first edge and a second edge;
a second L-shaped wall having a third edge and a fourth edge;
a peripheral wall assembly disposed around the first L-shaped wall and second L-shaped wall to define a fuel tank volume, the peripheral wall assembly including:
a first support surface extended between the first edge of the first L-shaped wall and the third edge of the second L-shaped wall; and
a second support surface extended between the second edge of the first L-shaped wall and the fourth edge of the second L-shaped wall, the second support surface being substantially perpendicularly attached to the first support surface, thereby defining a notched space of the fuel tank; and
a reductant tank retained in the notched space such that the reductant tank is attached to the first support surface and the second support surface.
